(19) United States
(12) Patent Application Publication
(10) Pub. No.: US 2026/0363318 A1
(43) Pub. Date: Nov. 19, 2026

(54) ELECTRONIC ATOMIZATION DEVICE

(71) Applicant: SHENZHEN FIRST UNION TECHNOLOGY CO., LTD., Shenzhen, Guangdong (CN)

(72) Inventors: Zhiyong CHEN, Shenzhen, Guangdong (CN); Ruilong HU, Shenzhen, Guangdong (CN); Linjian HUANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/126,033

(22) PCT Filed: Oct. 17, 2023
(86) PCT No.: PCT/CN2023/125042

§ 371 Date: Apr. 30, 2025

(30) Foreign Application Priority Data
Oct. 31, 2022 (CN) 202222917258.0

(51) Int. Cl. A24F 40/465; A24F 40/10; H05B 6/10; H05B 6/36

(52) U.S. Cl. CPC A24F 40/465; A24F 40/10; H05B 6/108; H05B 6/36

(57) ABSTRACT

An electronic atomization device including: an induction coil, configured to generate a changing magnetic field under an alternating current, and constructed as a tubular induction coil spirally wound around a first central axis; and a susceptor, configured to be penetrated by the changing magnetic field to generate heat, to heat a liquid substrate to generate an aerosol, and constructed as a tubular susceptor surrounding a second central axis, where when the electronic atomization device is in use, the susceptor is completely arranged in the induction coil along an axial direction, and an axial span of the induction coil along the first central axis is greater than an axial span of the susceptor along the second central axis, to completely cover the axial span of the susceptor.

This application claims priority to Chinese Patent Application No. 202222917258.0, filed with the China National Intellectual Property Administration on Oct. 31, 2022 and entitled “ELECTRONIC ATOMIZATION DEVICE”, which is incorporated herein by reference in its entirety.

### TECHNICAL FIELD

This application relates to the field of electronic atomization technologies, and in particular, to an electronic atomization device.

### BACKGROUND

An electronic atomization device is an electronic product that atomizes a liquid substrate to generate an aerosol for a user to inhale, and generally has two parts: an atomizer and a power supply assembly. The atomizer has the liquid substrate stored therein, and includes an atomization core for atomizing the liquid substrate. The power supply assembly includes a battery and a circuit board.

### SUMMARY

This application provides an electronic atomization device, including:
an induction coil, configured to generate a changing magnetic field under an alternating current, where the induction coil is constructed as a tubular induction coil spirally wound around a first central axis; and
a susceptor, configured to be penetrated by the changing magnetic field to generate heat, to heat a liquid substrate to generate an aerosol, where the susceptor is constructed as a tubular susceptor surrounding a second central axis, and
when the electronic atomization device is in use, the susceptor is completely arranged in the induction coil along an axial direction, and an axial span of the induction coil along the first central axis is greater than an axial span of the susceptor along the second central axis, to completely cover the axial span of the susceptor.

According to the electronic atomization device, the susceptor is completely arranged in the induction coil, so that coupling between the alternating magnetic field generated by the induction coil and the susceptor is significantly increased, and conversion efficiency of an induction heating assembly is improved.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an electronic atomization device according to an embodiment of this application;

FIG. 2 is a schematic exploded view of an electronic atomization device according to an embodiment of this application;

FIG. 3 is a schematic diagram of an atomizer according to an embodiment of this application;

FIG. 4 is a schematic cross-sectional view of an atomizer according to an embodiment of this application;

FIG. 5 is another schematic cross-sectional view of an atomizer according to an embodiment of this application;

FIG. 6 is a schematic exploded view of an atomization core according to an embodiment of this application;

FIG. 7 is a schematic cross-sectional view of a power supply assembly according to an embodiment of this application;

FIG. 8 is a schematic diagram of an induction coil according to an embodiment of this application;

FIG. 9 is a schematic cross-sectional view of an electronic atomization device according to an embodiment of this application;

FIG. 10 is a schematic cross-sectional view of an induction heating assembly according to an embodiment of this application; and

FIG. 11 is a schematic diagram of an induction heating assembly according to an embodiment of this application from another viewing angle.

### DETAILED DESCRIPTION

For ease of understanding of this application, this application is described in further detail below with reference to the accompanying drawings and specific embodiments. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific embodiments, and are not intended to limit this application. The term “and/or” used in this specification includes any or all combinations of one or more related listed items.

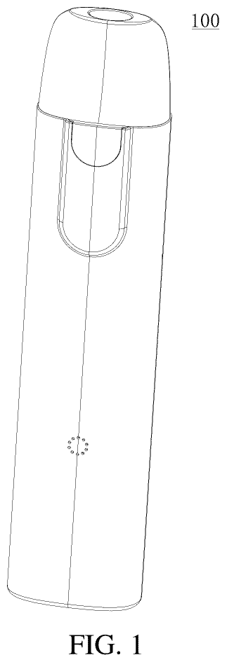

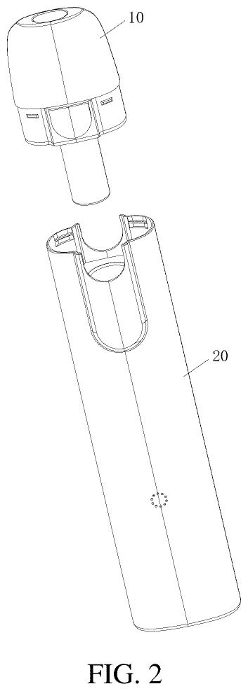

As shown in FIG. 1 and FIG. 2, an electronic atomization device 100 includes an atomizer 10 and a power supply assembly 20.

The atomizer 10 is detachably or removably connected to the power supply assembly 20. The detachable or removable connection includes, but is not limited to, a snap-fit connection, a magnetic connection, and a threaded connection. In some other examples, the atomizer 10 and the power supply assembly 20 may also be non-detachably connected.

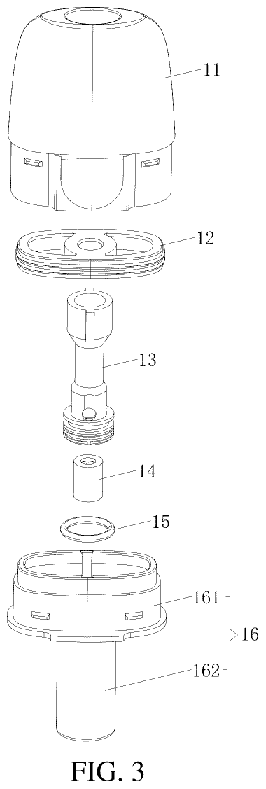

As shown in FIG. 3 to FIG. 6, the atomizer 10 includes an upper housing 11, a sealing member 12, an upper holder 13, an atomization core 14, a sealing member 15, and a base 16.

The upper housing 11 has a vaping end and an open end. The vaping end is provided with an outlet, and an atomized aerosol can be inhaled by a user through the outlet. The upper housing 11 further has a transmission tube 11a integrally formed therein. A part of an airflow channel is defined by an inner surface of the transmission tube 11a. An upper end of the transmission tube 11a is in communication with the outlet, and a lower end of the transmission tube 11a is connected to the upper holder 13.

A liquid storage cavity A is defined by an inner surface of the upper housing 11 and an inner surface of the base 16. The liquid storage cavity A is configured to store a liquid substrate that can generate an aerosol. It can be seen from the figures that, a part of the liquid storage cavity A extends into a second connection portion 162 of the base 16, and surrounds a susceptor 141.

The liquid substrate preferably includes a tobacco-containing material. The tobacco-containing material includes a volatile tobacco flavor compound released from the liquid substrate during heating. Alternatively or additionally, the liquid substrate may include a non-tobacco material. The liquid substrate may include water, ethanol, or other solvents, a plant extract, a nicotine solution, and a natural or artificial flavoring agent. Preferably, the liquid substrate further includes an aerosol former. Suitable examples of the aerosol former include glycerol and propylene glycol.

The sealing member 12 is arranged between the transmission tube 11a and the upper holder 13 and between the base 16 and the upper housing 11, to seal a gap between the transmission tube 11a and the upper holder 13 and a gap between the base 16 and the upper housing 11.

The upper holder 13 is retained in the base 16. The upper holder 13 is substantially tubular. A lower end of the upper holder 13 is received in the second connection portion 162, and an upper end of the upper holder 13 extends toward a first connection portion 161 of the base 16, and is connected to the transmission tube 11a. An inner hollow portion of the upper holder 13 defines a part of the airflow channel. An inner diameter or an outer diameter of a middle portion of the upper holder 13 is smaller than an inner diameter or an outer diameter of any other portion of the upper holder 13.

The atomization core 14 is received in the upper holder 13, and is arranged close to the lower end of the upper holder 13. After assembly, the atomization core 14 is completely located in the second connection portion 162 of the base 16. The atomization core 14 and the upper holder 13 or the second connection portion 162 are coaxially arranged. A side wall of the upper holder 13 is provided with a liquid hole, and the liquid substrate stored in the liquid storage cavity A can be transferred to the atomization core 14 through the liquid hole.

The atomization core 14 includes the susceptor 141. The susceptor 141 is configured to be coupled to the induction coil 26, and generate heat when being penetrated by a changing magnetic field, to heat the liquid substrate to generate the aerosol for inhalation. The susceptor 141 may be made of at least one of the following materials: aluminum, iron, nickel, copper, bronze, cobalt, plain carbon steel, stainless steel, ferritic stainless steel, martensitic stainless steel, or austenitic stainless steel.

The susceptor 141 is constructed as a tubular susceptor surrounding a second central axis S1. The susceptor 141 may have an elliptical, circular, square, rectangular, triangular, or other polygonal-shaped cross sections. For example, for a susceptor 141 having a circular cross section, the central axis S1 is a line connecting a center of the circular cross section at the top of the susceptor 141 and a center of the circular cross section at the bottom of the susceptor 141. For other shapes, the central axis S1 is defined similarly.

The susceptor 141 is axially arranged in the upper holder 13 or the second connection portion 162. In a preferred embodiment, the central axis S1 coincides with a central axis of the upper holder 13 or the second connection portion 162. An inner diameter of the susceptor 141 is in a range of 0.2 mm to 20 mm, a wall thickness of the susceptor 141 is in a range of 0.1 mm to 2 mm, and an axial span d1 of the susceptor 141 along the central axis S1 is in a range of 4 mm to 6 mm. In a specific example, the axial span d1 is 5 mm. A distance between a midpoint K1 of the axial span of the susceptor 141 along the central axis S1 and a bottom surface of the second connection portion 162 is d2, and a distance between the central axis S1 and an outer surface of the second connection portion 162 is d3. Descriptions are provided below.

The atomization core 14 may further include a liquid transfer unit 142, to absorb the liquid substrate through the liquid hole and transfer the absorbed liquid substrate to the susceptor 141. The liquid transfer unit 142 has a liquid retaining capability, and may have any suitable capillarity and porosity, to match different physical properties of the liquid substrate, such as density, viscosity, surface tension, and vapor pressure. Suitable examples of materials may include a ceramic or graphite material in a fiber or sintered powder form, or a porous metal, e.g., porous ceramics, porous glass, ceramic fibers, or porous metal fibers. Suitable examples of materials may include a natural or artificial fiber material, e.g., natural cotton fibers, glass fibers, a sponge, or a non-woven fabric. For example, the liquid transfer unit 142 is made of a fibrous material made of spun fibers or extruded fibers, such as cellulose acetate, polyester fibers, bonded polyolefin, polyethylene fibers, polypropylene fibers, and nylon fibers.

In a preferred embodiment, the liquid transfer unit 142 is made of porous ceramics, and the material of the porous ceramics includes at least one of the following: alumina, zirconia, kaolinite, diatomite, and montmorillonite. A porosity of the porous ceramics may be adjusted in a range of 10% to 90%, and an average pore size of the porous ceramics may be adjusted in a range of 10 μm to 150 μm. In some embodiments, the adjustment can be made by, for example, selecting the amount and particle size of the pore-forming agent added.

In this preferred embodiment, the liquid transfer unit 142 is hollow-cylindrical or hollow-tubular, and the shape of the susceptor 141 matches the shape of the liquid transfer unit 142. The susceptor 141 may be arranged on an inner surface of the liquid transfer unit 142 or embedded in the liquid transfer unit 142. An inner side wall of the hollow-cylindrical liquid transfer unit 142 defines or forms an atomization surface of the atomization core 14, an outer side wall of the hollow-cylindrical liquid transfer unit 142 defines or forms a liquid absorption surface for absorbing the liquid substrate, and a hollow portion of the hollow-cylindrical liquid transfer unit 142 defines a part of the airflow channel. The atomized aerosol and air can flow toward the outlet of the electronic atomization device 100 together.

The susceptor 141 has a plurality of through holes 141a spaced apart from each other. The through holes 141a have a pore size in a range of 0.1 mm to 0.5 mm, and may be circular, elliptical, triangular, rohmbic, or other regular or irregular shapes. The aerosol may escape from the atomization surface into the airflow channel through the through holes 141a. In some examples, the through holes 141a may further increase a binding force between the susceptor 141 and the porous ceramics after sintering, to improve the overall strength of the atomization core 14.

The sealing member 15 is sleeved on the upper holder 13. The sealing member 15 is configured to seal a gap between the upper holder 13 and the second connection portion 162.

The base 16 and the upper housing 11 constitute a housing assembly of the atomizer 10. The base 16 includes the first connection portion 161 and the second connection portion 162 that are integrally formed. The first connection portion 161 is received in the upper housing 11, and the second connection portion 162 is exposed outside the upper housing 11 or the atomizer 10. A radial dimension of the first connection portion 161 is greater than a radial dimension of the second connection portion 162. A cross section of the second connection portion 162 is elliptical or circular. An inlet is provided at a bottom end of the second connection portion 162. External air flows in through the inlet, and flows out from the outlet of the upper housing 11 after sequentially passing through the atomization core 14, the upper holder 13, and the transmission tube 11a.

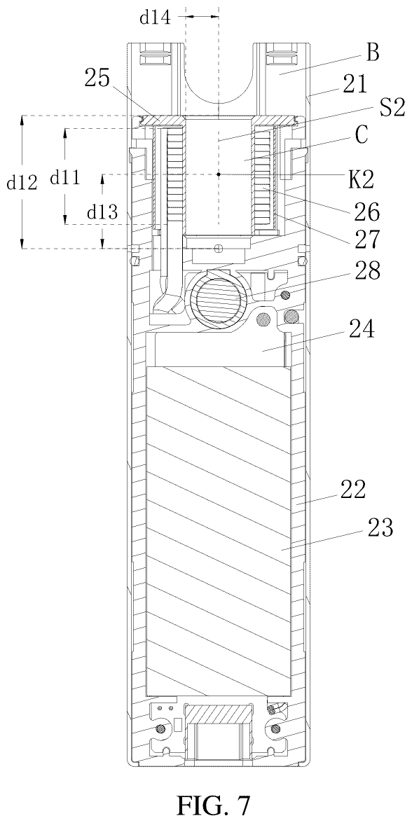

As shown in FIG. 7, the power supply assembly 20 includes a lower housing 21, a lower holder 22, a battery 23, a circuit 24, a base 25, an induction coil 26, a shield member 27, and a sensor 28.

The lower housing 21 has a cylindrical structure with two open ends. The lower housing 21 and the upper housing 11 define a housing of the electronic atomization device 100. An outer surface of the lower housing 21 is provided with an airflow entrance, and external air flows into the lower housing 21 through the airflow entrance. Outer surfaces of a front side and a rear side of the lower housing 21 partially protrude, so that the size of a part of the power supply assembly 20 in a thickness direction is increased, and a large-sized induction coil 26 can be accommodated.

The lower holder 22 is received in the lower housing 21, and the battery 23, the circuit 24, the base 25, the induction coil 26, the shield member 27, and the sensor 28 are all arranged on the lower holder 22. A dimension of the lower holder 22 in a length direction is smaller than a dimension of the lower housing 21 in the length direction. A receiving cavity B is defined between an upper end of the lower holder 22 and an upper end of the lower housing 21 or between the lower holder 22 and an inner surface of the lower housing 21. A lower end of the lower holder 22 abuts against an end portion of a lower end of the lower housing 21. After assembly, a part of the upper housing 11 is received in the receiving cavity B.

The battery 23 provides electric power for operating the electronic atomization device 100. The battery 23 may be a re-chargeable battery or a disposable battery.

The circuit 24 may control overall operation of the electronic atomization device 100. The circuit 24 controls operation of the battery 23 and the induction coil 26, and also controls operation of other elements in the electronic atomization device 100. The circuit 24 includes at least one processor. The processor may include a logic gate array, or may include a combination of a general-purpose microprocessor and a memory that stores a program executable in the microprocessor. In addition, a person skilled in the art should understand that, the circuit 24 may include hardware of another type.

The base 25 is substantially tubular, and an inner hollow portion of the base 25 defines or forms at least one part of a receiving cavity C. After assembly, the second connection portion 162 of the base 16 is at least partially received in the receiving cavity C. When the second connection portion 162 of the base 16 is received in the receiving cavity C, the first connection portion 161 is always in contact with the base 25, and the bottom surface of the second connection portion 162 and a bottom wall of the receiving cavity C are always in contact with each other or is spaced apart by a very small gap that can be ignored.

The induction coil 26 generates a changing magnetic field under an alternating current, and the battery 23 provides a high-frequency oscillation current to the induction coil 26. A frequency of the alternating current supplied to the induction coil 26 is in a range of 500 kHZ to 3 MHz. Preferably, the frequency may be in a range of 500 kHZ to 2.5 MHz. Further preferably, the frequency may be in a range of 500 kHZ to 2 MHz. Further preferably, the frequency may be in a range of 500 kHZ to 1.5 MHz. Further preferably, the frequency may be in a range of 500 kHZ to 1 MHz.

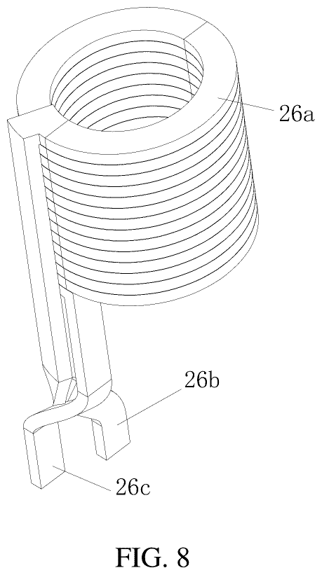

As shown in FIG. 8, a main part 26a of the induction coil 26 is constructed as a tubular induction coil spirally wound around the first central axis S2. The main part 26a is sleeved on or surrounds a periphery of the base 25, i.e., is arranged on a circumference of the receiving cavity C or surrounding the receiving cavity C. The main part 26a may have an elliptical, circular, square, rectangular, triangular, or other polygonal-shaped cross sections. For example, for a main part 26a having a circular cross section, the central axis S2 is a line connecting a center of the circular cross section at the top of the main part 26a and a center of the circular cross section at the bottom of the main part 26a. For other shapes, the central axis S2 is defined similarly. An electric connection portion 26b and an electric connection portion 26c of the induction coil 26 are configured to be electrically connected to the battery 23.

The main part 26a is formed by winding a long wire material, for example, by winding 500 to 2000 wires, or 500 to 1900 wires, or 700 to 1900 wires, or 900 to 1900 wires, or 1000 to 1900 wires, or 1200 to 1900 wires, or 1400 to 1900 wires, or 1600 to 1900 wires. A cross section of the wire material may be rectangular, circular, or elliptical.

The number of turns or windings of the main part 26a is in a range of 4 to 20, preferably, 6 to 20, further preferably, 6 to 15, further preferably, 6 to 12, and further preferably, 6 to 10. A spacing between adjacent turns or windings is approximately in a range of 0.1 mm to 0.5 mm. In a specific embodiment, the spacing between adjacent turns or windings is 0.2 mm or 0.4 mm.

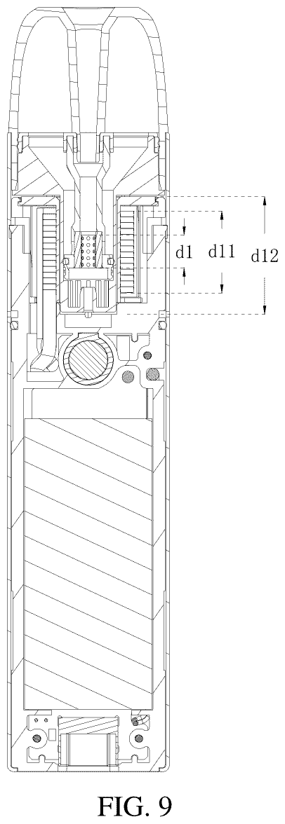

Based on factors such as the design of the susceptor 141 or the overall design of the electronic atomization device 100, the axial span d1 of the susceptor 141 along the central axis S1 is usually less than or equal to one third (approximately between one fourth and one third) of the axial span of the second connection portion 162. To ensure that the susceptor 141 can be completely arranged in the induction coil 26 when the second connection portion 162 of the base 16 is received in the receiving cavity C, an axial span d11 of the induction coil 26 along the central axis S2 is greater than the axial span d1 of the susceptor 141 along the central axis S1, and the axial span d11 of the induction coil 26 along the central axis S2 is greater than or equal to two thirds of an axial span d12 of the receiving cavity C along the central axis S2, and a maximum of the axial span d11 may be equal to d12. In this way, the susceptor 141 can be completely arranged in the induction coil 26, and coupling between the alternating magnetic field generated by the induction coil 26 and the susceptor 141 is significantly increased. FIG. 9 shows a case in which the susceptor 141 is completely arranged in the induction coil 26. The susceptor 141 being completely arranged in the induction coil 26 means that an upper end and a lower end of the susceptor 141 and an upper end and a lower end of the induction coil 26 are correspondingly spaced apart from each other.

In an example, the axial span d11 of the induction coil 26 along the central axis S2 may be greater than or equal to two times the axial span d1 of the susceptor 141 along the central axis S1. Preferably, d11 is in a range of two times to three times the axial span d1 of the susceptor 141 along the central axis S1.

In an example, the axial span d11 of the induction coil 26 along the central axis S2 is in a range of 10 mm to 15 mm, preferably, 10 mm to 14 mm, further preferably, 10 mm to 13 mm, and further preferably, 11 mm to 13 mm.

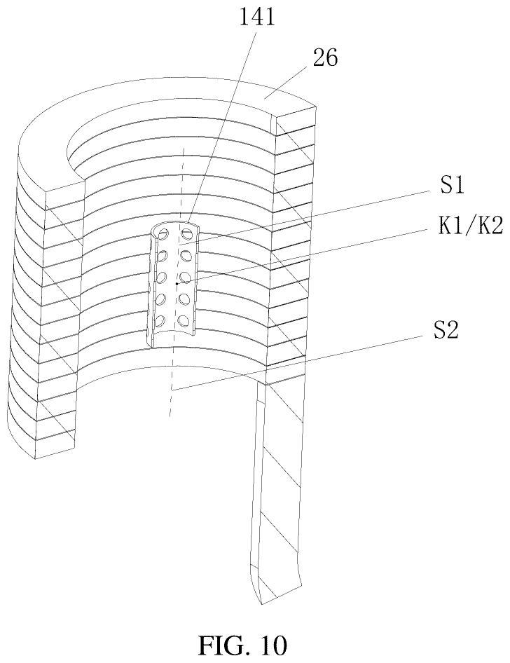

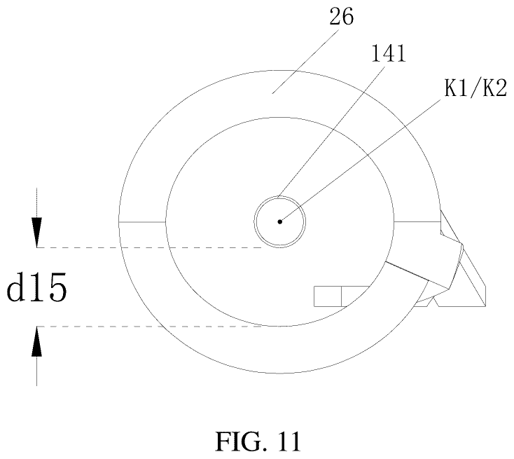

In a further embodiment, an offset distance between the central axis S1 of the susceptor 141 and the central axis S2 of the induction coil 26 is in a range of 0 mm to 3 mm (including endpoint values). An offset distance between the midpoint K1 of the axial span of the susceptor 141 along the center axis S1 and the midpoint K2 of the axial span of the induction coil 26 along the center axis S2 is in a range of 0 mm to 3 mm (including endpoint values). When the offset distance between the central axis S1 of the susceptor 141 and the central axis S2 of the induction coil 26 is 0 mm, it means that the central axis S1 coincides with the central axis S2. When the distance between the midpoint K1 of the axial span of the susceptor 141 along the central axis S1 and the midpoint K2 of the axial span of the induction coil 26 along the central axis S2 is 0 mm, it means that a center of the susceptor 141 coincides with a center of the induction coil 26, or an axial center of the susceptor 141 coincides with an axial center of the induction coil 26. FIG. 10 and FIG. 11 show a case in which the center of the susceptor 141 coincides with the center of the induction coil 26, and the axial center of the susceptor 141 coincides with the axial center of the induction coil 26.

This is advantageous. The alternating magnetic field generated by the induction coil 26 is the strongest at the center of the induction coil 26, and is weak at two ends of the induction coil 26. Therefore, when the central axis S1 coincides with the central axis S2, and the center of the susceptor 141 coincides with the center of the induction coil 26, it means that the coupling between the alternating magnetic field generated by the induction coil 26 and the susceptor 141 is optimal, and conversion efficiency of an induction heating assembly formed by the induction coil 26 and the susceptor 141 is optimal.

A test was carried out by adjusting the distance between the central axis S1 and the central axis S2 (corresponding to D2 in the following table) and the distance between the midpoint K1 of the axial span of the susceptor 141 along the central axis S1 and the midpoint K2 of the axial span of the induction coil 26 along the central axis S2 (corresponding to D1 in the following table). The test result is as follows.

| Sequence number | D1 | D2 | Conversion efficiency |
|---|---|---|---|
| 1 | 0 | 0 | 85.34% |
| 2 | 1 mm | 0 | 74.58% |
| 3 | 2 mm | 0 | 63.26% |
| 4 | 3 mm | 0 | 51.24% |
| 5 | 0 | 1 mm | 72.56% |
| 6 | 0 | 2 mm | 59.76% |
| 7 | 0 | 3 mm | 46.59% |

The test result shows that when the central axis S1 coincides with the central axis S2, and the center of the susceptor 141 coincides with the center of the induction coil 26, the conversion efficiency of the induction heating assembly is optimal, which is approximately 85.34%; when the distance between the central axis S1 and the central axis S2 increases, or the distance between the midpoint K1 of the axial span of the susceptor 141 along the central axis S1 and the midpoint K2 of the axial span of the induction coil 26 along the central axis S2 increases, the conversion efficiency of the induction heating assembly decreases; and a change in the distance between the central axis S1 and the central axis S2 has a greater impact on the conversion efficiency of the induction heating assembly than a change in the distance between the midpoint K1 of the axial span of the susceptor 141 along the central axis S1 and the midpoint K2 of the axial span of the induction coil 26 along the central axis S2.

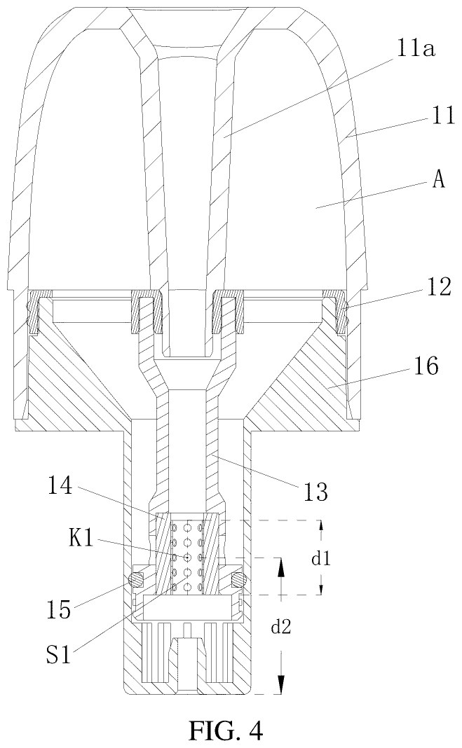

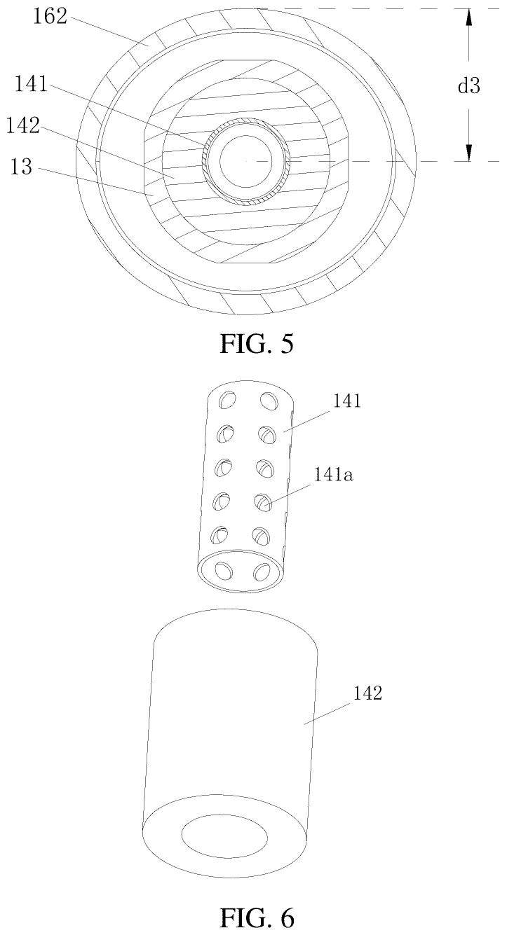

Referring to FIG. 4, FIG. 5, and FIG. 7, similarly, the distance between the midpoint K1 of the axial span of the susceptor 141 along the central axis S1 and the bottom surface of the second connection portion 162 is d2, a distance between the midpoint K2 of the axial span of the induction coil 26 along the central axis S2 and the bottom wall of the receiving cavity C is d13, and a difference between d2 and d13 is in a range of 0 mm to 3 mm. The distance between the central axis S1 and the outer surface of the second connection portion 162 is d3, a distance between the central axis S2 and an inner wall of the receiving cavity C is d14, and a difference between d3 and d14 is in a range of 0 mm to 3 mm.

In a further embodiment, a minimum radial distance d15 between the induction coil 26 and the susceptor 141 is in a range of 3 mm to 7 mm, preferably, 3 mm to 6 mm, further preferably, 4 mm to 6 mm. This ensures the coupling between the alternating magnetic field generated by the induction coil 26 and the susceptor 141.

The shield member 27 surrounds or is sleeved over the induction coil 26. The shield member 27 is configured to shield a magnetic field radiated by the induction coil 26 approximately along the radial direction, to prevent the radiated magnetic field from affecting other components.

The sensor 28 senses a change of airflow in the lower housing 21 through a sensing channel, i.e., detects vaping of the user, to generate a signal to control the atomizer 10 to start to operate.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the above technical features may further be combined to form various embodiments not listed above, and all such embodiments shall be construed as falling within the scope of the specification of this application. Further, a person of ordinary skill in the art may make improvements and variations according to the above descriptions, and such improvements and variations shall all fall within the protection scope of the appended claims of this application.

What is claimed is:

1. An electronic atomization device, comprising:
an induction coil, configured to generate a changing magnetic field under an alternating current, wherein the induction coil is constructed as a tubular induction coil spirally wound around a first central axis; and
a susceptor, configured to be penetrated by the changing magnetic field to generate heat, to heat a liquid substrate to generate an aerosol, wherein the susceptor is constructed as a tubular susceptor surrounding a second central axis, and
when the electronic atomization device is in use, the susceptor is completely arranged in the induction coil along an axial direction, and an axial span of the induction coil along the first central axis is greater than an axial span of the susceptor along the second central axis, to completely cover the axial span of the susceptor.

2. The electronic atomization device according to claim 1, wherein an offset distance between the first central axis and the second central axis is in a range of 0 mm to 3 mm.

3. The electronic atomization device according to claim 1, wherein an offset distance between a midpoint of the axial span of the induction coil along the first central axis and a midpoint of the axial span of the susceptor along the second central axis is in a range of 0 mm to 3 mm.

4. The electronic atomization device according to claim 1, wherein a minimum radial distance between the induction coil and the susceptor is in a range of 3 mm to 7 mm.

5. The electronic atomization device according to claim 1, wherein the axial span of the induction coil along the first central axis is greater than or equal to two times the axial span of the susceptor along the second central axis.

6. The electronic atomization device according to claim 1, wherein the axial span of the induction coil along the first central axis is in a range of 10 mm to 15 mm.

7. The electronic atomization device according to claim 1, wherein the axial span of the susceptor along the second central axis is in a range of 4 mm to 6 mm.

8. The electronic atomization device according to claim 1, wherein the induction coil has an elliptical, circular, square, rectangular, triangular, or other polygonal-shaped cross sections; and
the susceptor has an elliptical, circular, square, rectangular, triangular, or other polygonal-shaped cross sections.

9. The electronic atomization device according to claim 1, wherein an operating frequency provided to the induction coil is in a range of 500 kHZ to 3 MHz.

10. The electronic atomization device according to claim 1, wherein the electronic atomization device comprises a power supply assembly and an atomizer removably connected to the power supply assembly;
the power supply assembly comprises a power supply configured to provide a high-frequency oscillation current to the induction coil, a receiving cavity configured to receive at least one part of the atomizer, and the induction coil, wherein the induction coil is arranged surrounding the receiving cavity; and
the susceptor is axially arranged in the at least one part of the atomizer.

11. The electronic atomization device according to claim 10, wherein the axial span of the induction coil along the first central axis is greater than or equal to two-thirds of the axial span of the receiving cavity along the first central axis; and/or
the axial span of the susceptor along the second central axis is less than or equal to one third of an axial span of the at least one part of the atomizer received in the receiving cavity.

12. The electronic atomization device according to claim 10, wherein the power supply assembly further comprises a base, the receiving cavity is defined by at least one part of the base, and the induction coil surrounds a periphery of the base.

13. The electronic atomization device according to claim 12, wherein a distance between the first central axis and an inner wall of the receiving cavity and a distance between the second central axis and an outer surface of the at least one part of the atomizer received in the receiving cavity are the same or have a difference of 3 mm or less.

14. The electronic atomization device according to claim 10, wherein a distance between a midpoint of the axial span of the induction coil along the first central axis and a bottom wall of the receiving cavity and a distance between a midpoint of the axial span of the susceptor along the second central axis and a bottom surface of the atomizer are the same or have a difference of 3 mm or less.
